(19) United States
(12) Patent Application Publication
(10) Pub. No.: US 2016/0321943 A1
(43) Pub. Date: Nov. 3, 2016

(54) Alternating Language Learning System and Method

(71) Applicant: Michael G. Frank, Brooklyn, NY (US)

(72) Inventor: Michael G. Frank, Brooklyn, NY (US)

(21) Appl. No.: 15/143,606

(22) Filed: May 1, 2016

Related U.S. Application Data
(60) Provisional application No. 62/155,586, filed on May 1, 2015.

(51) Int. Cl. G09B 17/00; G09B 19/08; G09B 5/12

(52) U.S. Cl. CPC G09B 17/003; G09B 5/125; G09B 19/08

(57) ABSTRACT

The present disclosure is an improvement in language immersion learning which utilizes a dual language alternating platform and method to enhance the reader's ability to comprehend and learn a foreign language. The method can include the use of an e-book or similar digital device by the reader. The method can include alternating chapter format. This improved method may include historic publications, educational text, books for children, young adults etc. The user has the option to alternate between chapters in their native language or a foreign language. This method compels the reader to remain immersed in the foreign language throughout the chapter for increased comprehension.

### CROSS-REFERENCE TO RELATED APPLICATIONS

This application is based on the provisional application 62/155,586, filed May 1, 2015.

### BACKGROUND OF THE INVENTION

This application relates to a dual language interactive chapter electronic book (hence forth e-book) format designed to help and improve foreign language comprehension. This adaptive immersion method of learning a new language is efficient and systematic. The platform encompasses a method which includes but is not limited to an option for alternating chapters that encourages and builds confidence as the learner progresses in their study.

The ability to read and comprehend more than one language is valuable in our global economy. Traditionally, to learn and comprehend a new language a language learner recites key terms in the foreign language and then native language. If the language leaner comes across a word that is not understood they must look up the term to continue the learning process. This process is tedious, inefficient and disrupts the natural flow of continuous reading. Yet, with the advent of e-books the language learner has been able to expand methods of language learning by reading one sentence in foreign language then the next in their native language. This provides little advantage in preserving the natural cadence of reading, as the reader is constantly switching out of the story to check the translation. Yet, presently the methodologies and platforms to alternate between chapters for efficient substantial comprehension are limited. E-books and physical books which include the translation on an opposing page, or above or below the native language all have the same weakness, in that they present the user with an almost unavoidable temptation to simply read the text in their native language, as it is only a glance away. The solution described in this platform and method removes this temptation.

With a new language learner comprehension, grammar and syntax are big hurdles to understanding the foreign language. A method commonly used is repetition of the foreign language and the native language many times in several sentences. However, the language learner may lose the meaning sentences and pronunciation of the word, and fail syntax grammar rules immediately after reading or some thereafter. Further, techniques which immerse a new language learner, though effective, are time consuming and present obstacles all but the most dedicated students.

### ADVANTAGES

The advantages of one or more aspects of these methods is to allow for efficient learning of an additional language in an enjoyable flexible manner and attract a segment of technologically comfortable language learners which traditionally went untapped. The method can be adapted to any book which has an existing translation, opening up hundreds of thousands of titles to be read in the dual language alternating chapter format, including education and young adult books which are suitable for students. Other advantages of one or more aspects includes giving the language learner the option to continue the segment in the new language or the native language. Another advantage of one or more aspects is no special application is needed: the device works on all standard and e-Readers using native e-Reader formats such as .mobi and ePub. Further, the reader can be applied to any text by using the framework with no special coding required outside of a basic HTML framework. This distraction free method also allows complete immersion in the foreign language while reading. Another advantage of one or more aspects the user select and change the order in which they will be exposed to the foreign text. Thus, several advantages of one or more aspects of the alternating language learner system is the freedom the reader has to develop a learning environment which works best for their life. These and other advantages will become apparent from a consideration of the accompanying drawings and description.

### SUMMARY OF INVENTION

In one aspect, the dual language alternating chapter system and method allows the language learner to experience the challenge of reading a text in a foreign language. This is a overlapping method of reading a book that compels one to read and entire chapter in a foreign language of which they may have little comprehension. Instead of interrupting the flow of reading a story by looking up terms they don't understand the learner pushes through the chapter despite low or limited comprehension. They then have the opportunity to re-read the chapter in their native language to solidify comprehension, or skip ahead in either language. The e-book uses hyperlinks to guide the reader through the combined set of books, effectively allowing the language learner to re-read the chapter in their native language, improving understanding of the story and improving the comprehension through immediate comparison (a reward) or they can move ahead continuing with the new chapter in English or the alternate a language.

The alternating cycle of challenge and reward benefit the language learner's comprehension. The system uses standard HTML hyperlink technology, arranged in a proprietary format that guides the learner through the book in a manner that maximizes comprehension, and minimizes the disruption of looking up individual words or sentences The ability to look up an individual word is always available through the native e-book dictionary library, but this is not the primary means to learn the language. The reader will complete the book having essentially read the entire book in the foreign language, using the translated chapters as a means to solidify comprehension of the completed chapter, or prepare for reading the next chapter in the foreign language.

### BRIEF DESCRIPTION OF DRAWINGS

FIG. 1 Describes a non-limiting example of an e-reader, GrokReader or mobile device displaying the dual language option. This option can be translated or in the original language, with the option of alternating language chapters according to one embodiment of the present disclosure.

FIG. 2 Describes a non-limiting example of the end of a chapter using the alternating language system with the option to re-read the chapter in a native language or continue continuing the next chapter in the native language according to one embodiment of the present disclosure.

FIG. 3 Describes a non-limiting example of the end of a chapter using the alternating language system with the option to re-read the chapter in the foreign language or continue to the next chapter in the readers native language according to one embodiment of the present disclosure.

FIG. 4 Describes a non-limiting example of a flow chart of the e-book GrokReader with language options included according to one embodiment of the present disclosure.

FIG. 5 Describes a non-limiting example of e-book reader screen shot of the application in use according to one embodiment of the present disclosure.

Corresponding reference characters indicate corresponding parts throughout the several views. Although the drawings represent embodiments of the present disclosure, the drawings are not necessarily to scale and certain features may be exaggerated in schematic form or generalized in order to better illustrate and explain the present disclosure in the interest of clarity.

### DETAILED DESCRIPTION

In the present disclosure provided herein, are certain embodiments including a system and method to enable a person of ordinary skill in the art to make and use the embodiments of the present disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding technical field, background, brief summary or the following detailed description. The present disclosure should be accorded scope consistent with the claims, and not limited to the examples described and shown herein.

Furthermore, every feature and embodiment disclosed and claimed have the ability to be made without undue experimentation in light of what is disclosed herein. Substitutes, modifications or alternative arrangement of this invention will be apparent to those skilled in the art as they will be within the scope of this invention as defined by the claims. Some features and embodiments may be described as preferred, it is apparent to those skilled in the art that variations to certain embodiments may be applied without departing from the scope or concept of the invention, as a whole.

To assist in understanding the disclosed invention certain terms are defined below. The terms defined have common meanings understood by those of ordinary skill in the art. The terminology included illustrates specific embodiments, but does not delimit the invention, except as outlined in the claims. To assist in understanding the disclosed invention certain terms are defined below. The terms defined have common meanings understood by those of ordinary skill in the art.

As seen herein throughout the application the words “having” (and any form of having: has, have, etc.), “including” (and any form of including: include, includes, etc.) or “containing” (and any form of containing: contains, contain, etc.) are open-ended or inclusive and do not exclude additional, method steps or elements not mentioned.

As seen herein throughout the application the terms “a” or “an” used in conjunction with the term “comprising” in the specification and/or claims may mean “one”, “one or more”, “on or more than one” and “at least one”. As used herein the term “about” is used to indicate a value that includes the method being employed to determine a value, the inherent variation or error for the device or the variation that exists among them when comparing subjects. Additionally, as used herein the term “or” in the claims is used to mean “and/or” unless explicitly indicated to refer to alternatives only or the alternatives are mutually exclusive, although the disclosure supports a definition that refers to alternatives only and “or/and”.

As seen herein throughout the application the term “e-book” means an electronic or digital book or publication that is traditional to book length. The “e-book” consists of images and text readable on a computer, e-book reader or other digital device. The term can include books based on printed texted or the e-book can be the only rendition of the book.

As seen herein throughout the application the term “immersion” or “language immersion” means to speak, read or write completely in a language other than their native tongue. Further, complete dedication to the foreign language with an option or reference the native tongue for increase comprehension.

As seen herein throughout the application the term “GrokReader” relates to an interwoven, overlapping book format. This compels the language leaner to read the entire chapter in the foreign language.

The embodiments disclosed below are not intended to be exhaustive or limit the disclosure to the precise forms disclosed in the following detailed description. Rather, the embodiments are chosen and described so that others skilled in the art may utilize their teachings. Accordingly, the principle features of the invention can be disclosed in multiple embodiments without departing from the scope of the present invention.

Furthermore, every feature and embodiment disclosed and claimed have the ability to be made without undue experimentation in light of what is disclosed herein. Substitutes, modifications or alternative arrangement of the invention is apparent to those skilled in the art are within the scope of the invention as defined by the claims. Some features and embodiments may be described as preferred, it is apparent to those skilled in the art that variations to certain embodiments may be applied without departing from the scope or concept of the invention.

Embodiments of the disclosure are described herein in the context of one practical non-limiting application, namely, a Dual Language Interactive Alternating Chapter books. Embodiments of the disclosure, however, are not limited to such e-book or GrokReader applications described herein, and the embodiments may also be utilized in other applications. For example, embodiments may be applicable to cellular phones, iPods™, iPads™, tablet personal computers, mobile entertainment devices, e-textbooks, and the like.

In another aspect many language instruction programs provide some interactivity with the user to assist the user in learning the foreign language. One common technique is providing certain questions about the object or event depicted and the corresponding foreign language description. Thus, a video component may be presented showing an interaction involving asking for directions to the airport. A question may be presented to the user to assess the user's understanding of the foreign language—for example, “Is the airport on the left or right?” The user may be rewarded with points for correctly answering the question. With advances in technology the language leaner should be able read a book and improve language comprehension while reading original foreign texts.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

As a general matter, it is believed that providing descriptions in a foreign language of a particular event from more than one perspective enhances the ability of language students to learn the foreign language in an immersion context. As described above, with most conventional language learning programs, a single foreign language text description is presented to the user and is associated with a particular event that is visually displayed. Because only a single foreign language description of the event is presented, if the user does not understand some of the words in that description, he or she must resort to the translation of that text description in the user's native language. This reliance on the translation takes the user out of the immersion context, and thus the user loses the advantages associated with the immersion technique.

It is therefore the object of the present invention to utilize alternating language books with overlapping method of reading books; this method presents challenges and rewards to increase language comprehension. The reader uses standard Kindle™ and iBook™ formats (.mobi and .epub) to allow the reader to read each book and use the hyper link functionality on a standard reading device. This interwoven and overlapping book format compels users to read the complete chapter in the original foreign language. When users reach the end of each chapter, there is a link to re-read the chapter in English to which compels understanding of what was previously read. The user may choose to click a link to jump to the next chapter in English or original foreign language. The language leaner will read a chapter of a book in the native language and the reader may choose to re-read the chapter in a foreign language or go on to the next chapter in her native tongue. The interwoven chapters gives the language learner options at the end of each chapter to reverse the process start with a foreign language or recap in the reader's native language.

In another embodiment Alternating Language books may be in a format which the languages are in a convenient printed book format. In another aspect, a word for word translation appears each chapter in the foreign language and the native language. In another aspect, the corresponding accurately translated chapters in the first and second languages appear in a side by side arrangement so the reader can compare. The comparison is present to promote a more efficient comprehension for the language learner.

In another aspect of the language learner has the ability to navigate between chapters using hyperlinks. The hyperlinks provide reader flexibility and the choice to continue in the native language or the foreign language. This allows for seamless transitions between chapters for the language leaner while increasing comprehension since the language learner can return to the same chapter via hyperlink to reinforce the understanding of the material.

In another aspect the language leaner has the ability to store words which have been looked up, to create a custom dictionary of challenging words for study or sharing on social media.

In the description the drawing figures are not necessarily to scale and particular features may be exaggerated in scale, schematic form or generalized in the interest of clarity and conciseness.

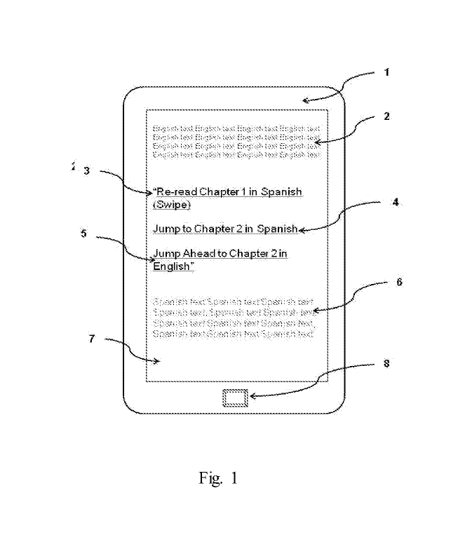

FIG. 1, depicts the e-reader or mobile device (1). Displayed on the screen of the e-reader or mobile device there is an entire chapter of the dual language book in the translated language (for example English) (2). Further, there is an option at the end of the chapter which allows the chapter to be re-read in the translated language, facilitated by inter-weaving the chapters of the e-book (3). Additionally, there is a hyperlink depicted that allows the language leaner to skip the translation and read the next chapter in the original language (4), or a hyperlink that allows the language leaner to toggle to the following chapter with the option to begin with the translated language first (5). There is also a depiction of the entire chapter of the dual language book in the original language (for example Spanish) (6). Furthermore, displayed is a touch sensitive area where the next page can be selected or the next chapter in the alternating chapter sequence (7). This display includes an e-reader control to move between hyperlinks for non-touch or devices which do not have a touch screen (8).

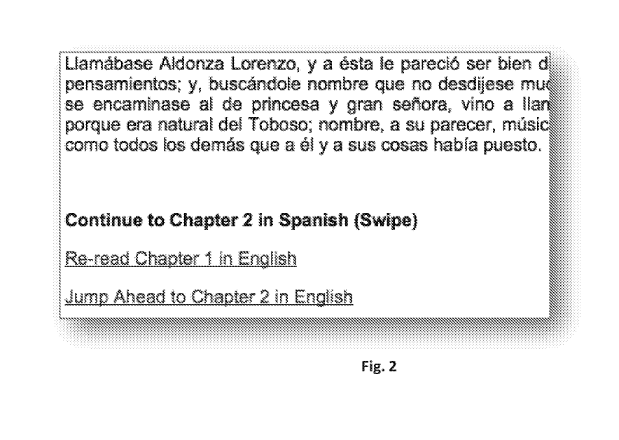

FIG. 2, depicts a screen shot of the end of a chapter in Spanish. The language learner has to option to click on a hyperlink to re-read the chapter in their native langue or jump ahead to the next chapter in their native language (here seen in English).

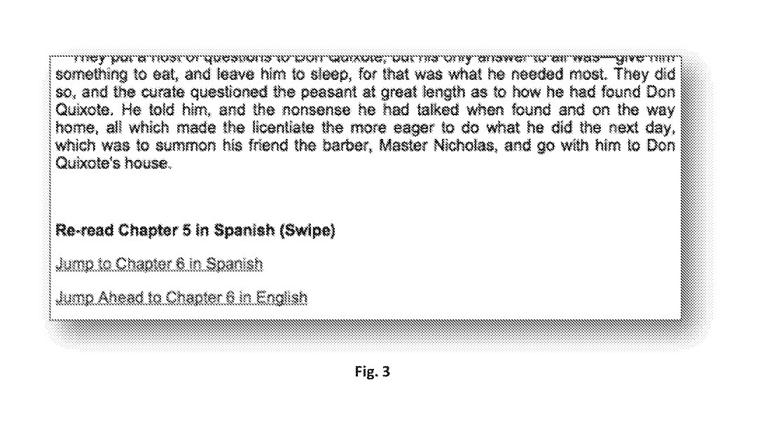

FIG. 3, depicts a screen shot of the end of a chapter in English. The language learner has to option to click on a hyperlink to re-read the chapter in the foreign language or jump ahead to the next chapter in the foreign language (here seen in Spanish).

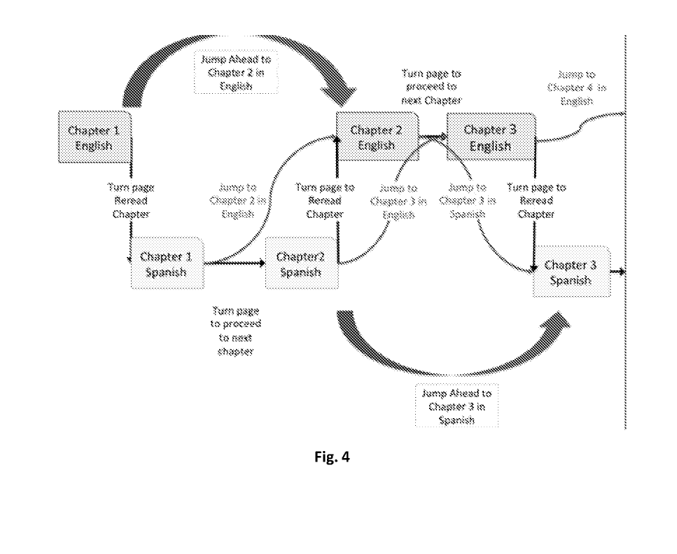

FIG. 4, depicts a flowchart of the e-book: GrokReader. In this example the native language is English and the foreign language is Spanish. In Chapter 1 the language leaner reads in English with the option to jump ahead to Chapter 2 in English. They also have the option to re-read Chapter 1 in Spanish. If the language leaner chooses to re-read Chapter 1 in Spanish they may either read Chapter 2 in Spanish or jump to Chapter 2 in English. If the language learner decides to read Chapter 2 in English they have the option to re-read Chapter 2 in Spanish or jump ahead to Chapter 3 in English. After completing Chapter 2 in Spanish the language learner has the option to read Chapter 3 in Spanish or jump ahead to read Chapter 3 in English. This example is not limited to the languages include and could have any variation of language in this dual language alternating platform.

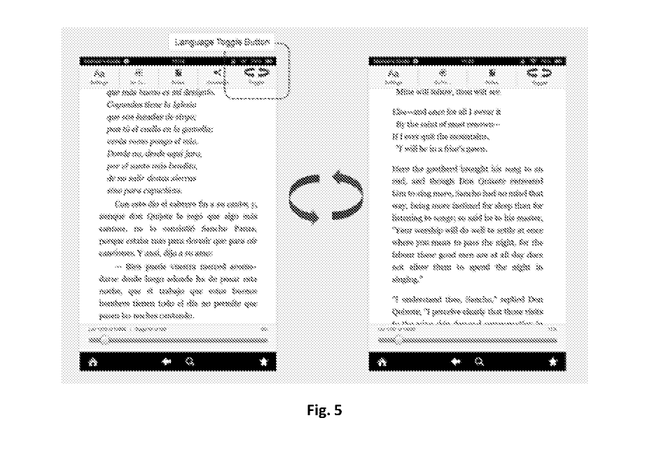

FIG. 5, displays a screen shot of an e-book reader which has the ability to toogle between two languages. Displayed, shows language learners ability to go to different pages, adjust settings for the font, save page to favorites, increase or decrease magnification or return to the home page.

### CONCLUSION, RAMIFICATION AND SCOPE

Accordingly, the language learner will see the GrokReader and various embodiments may be used to efficiently develop foreign language comprehension. Furthermore, one or more aspects uses an immersion model to increase foreign language comprehension. Thus, several advantages of one or more aspects is for efficient learning of an additional language in an enjoyable flexible manner and attract a segment of technologically comfortable language learners that traditionally went untapped.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains. All features and embodiments disclosed and claimed herein can be prepared and executed without undue experimentation in light of the present disclosure.

What is claimed:

1. A dual language alternating chapter system platform wherein particular components utilize an apparatus for input and output of parameters for a plurality of language learning purposes comprising:
a. a digital device to facilitate alternating language learning;
b. a electronic book reader or other digital device. Wherein, an entire publication with chapters is available therein;
c. a digital platform which connects to the internet and allows for a plurality of digital communication.

2. The alternating language system according to claim 1, wherein an entire publication is available in a foreign language and a native language.

3. The alternating language system according to claim 1, wherein there is an option at end of chapter to allow the chapter to be re-read in the translated language, facilitated by the option to interweave chapters in said e-book.

4. The alternating language system according to claim 1, wherein a plurality of hyperlinks allow user to read chapter in foreign language.

5. The alternating language system according to claim 1, wherein a plurality of hyperlinks allow user to read chapter in native language.

6. The alternating language system according to claim 1, wherein a touch sensitive display is used to navigate between pages or chapters.

7. The alternating language system claim 1, wherein electronic reader controls movement between hyperlinks using digital navigation for non-touch sensitive devices.

8. The alternating language learning method according to claim 1, wherein the reader reads an entire segment of text in a language other than said reader's native language and is prompted to continue in a foreign language or the reader's native language.

9. An alternating language learning method wherein particular components utilize an apparatus for input and output of parameters for a plurality of language learning purposes comprising:
a. a digital device to facilitate alternating language learning;
b. a electronic book reader or other digital device. Wherein, an entire publication with chapters is available therein;
c. a digital platform which connects to the internet and allows for a plurality of digital communication.

10. The alternating language method according to claim 9, wherein an entire publication is available in foreign language and native language.

11. The alternating language learning method according to claim 9, wherein there is an option at end of chapter to allow the chapter to be re-read in the translated language, facilitated by the option to interweave chapters in the e-book.

12. The alternating language learning method according to claim 9, wherein a plurality of hyperlinks allow user to read chapter in foreign language.

13. The alternating language learning method according to claim 9, wherein a plurality of hyperlinks allow user to read chapter in native language.

14. The alternating language learning method according to claim 9, wherein a touch screen is used to navigate between pages or chapters.

15. The alternating language learning method according to claim 9, wherein electronic reader controls movement between hyperlinks using digital navigation for non-touch sensitive devices.

16. The alternating language learning method according to claim 9, wherein the reader reads an entire segment of text in a language other than said reader's native language and is prompted to continue in a foreign language or the reader's native language.

17. A dual language interactive alternating language publication comprising:
a. a chapter in the language learners native language;
b. a chapter in the foreign language the leaner is interested in learning.

18. The dual language interactive alternating language publication according to claim 17, wherein there is an option at end of chapter to allow chapter to be re-read in the translated language, facilitated by the option to interweave chapters in the e-book.

19. The dual language interactive alternating language publication according to claim 17, wherein a plurality of hyperlinks allow user to read chapter in a foreign language.

20. The dual language interactive alternating language publication according to claim 17, wherein a plurality of hyperlinks allow user to read chapter in a native language.
